(19) United States
(12) Patent Application Publication
(10) Pub. No.: US 2011/0151794 A1
(43) Pub. Date: Jun. 23, 2011

(54) COMMUNICATION APPARATUS, METHOD OF CONTROLLING THE SAME, AND COMPUTER-READABLE MEDIUM

(75) Inventor: Hiroshi Mashimo, Tokyo (JP)

(73) Assignee: CANON KABUSHIKI KAISHA, Tokyo (JP)

(21) Appl. No.: 12/960,189

(22) Filed: Dec. 3, 2010

(30) Foreign Application Priority Data
Dec. 18, 2009 (JP) 2009-288467

(51) Int. Cl. H04B 15/00

(52) U.S. Cl. 455/63.1

(57) ABSTRACT

A communication apparatus according to the present invention includes a reservation unit configured to reserve a time frame to communicate with a communication partner, a determination unit configured to determine presence or absence of an interference with the communication partner in the communication with the communication partner using the time frame reserved by the reservation unit, and a masking unit configured to mask the time frame when the determination unit determines presence of the interference.

### BACKGROUND OF THE INVENTION

1. Field of the Invention

The present invention relates to a communication apparatus that communicates with communication partner in a predetermined cycle.

2. Description of the Related Art

Conventionally, a Host under the Wireless Universal Serial Bus (WUSB) standard that is an upper level protocol of the WiMedia standard reserves a medium access slot (MAS) for communication among MASs in a superframe that is repeated in a predetermined time cycle. A medium access slot (MAS) is a time slot that is used for communication between communication apparatuses (a Host and its communication partner) specified by the WiMedia standard. The Host notifies information of the reserved MAS with a beacon. The communication apparatus uses the MAS reserved by the Host to communicate in a predetermined time cycle.

When making the reservation, the Host detects beacons transmitted from other Hosts, and reserves a MAS different from those reserved by the other Hosts. This enables the Host to communicate without interference.

Even if there is no interference on the Host side, a communication partner of the Host may suffer from interference. For example, when first and second Hosts cannot mutually detect their beacons and accidentally reserve a MAS in the same time zone, the communication partners of the Hosts interfere with one another. In addition, the first and second Hosts, which cannot detect interference at their communication partners, continue the communication using the MAS. The communication apparatuses each communicate in a predetermined cycle, which causes continuous interferences at each of the communication partners of the first and second Hosts, resulting in poor communication quality. Further, if the first Host cancels the reservation of the MAS, a third Host residing in the communication range of the first Host may reserve the MAS to cause another interference.

### SUMMARY OF THE INVENTION

The present invention is directed to provide an apparatus that prevents other communication apparatuses from using a time frame that causes interference in its communication partner.

According to an aspect of the present invention, a communication apparatus includes a reservation unit configured to reserve a time frame to communicate with a communication partner, a determination unit configured to determine presence or absence of interference at the communication partner in the communication with the communication partner using the time frame reserved by the reservation unit, and a masking unit configured to mask the time frame when the determination unit determines presence of the interference.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A-1B each illustrate a system configuration.

FIGS. 2A-2B each illustrate a frame configuration.

FIG. 3 illustrates a case where the interference occurs.

FIGS. 4A-4B each illustrate a hardware configuration of a Host.

FIG. 5 is a flowchart executed by a Host.

FIG. 6 illustrates a software configuration executed by a Host.

FIGS. 7A-7B each illustrate a MAS table.

### DESCRIPTION OF THE EMBODIMENTS

Various exemplary embodiments, features, and aspects of the invention will be described in detail below with reference to the drawings.

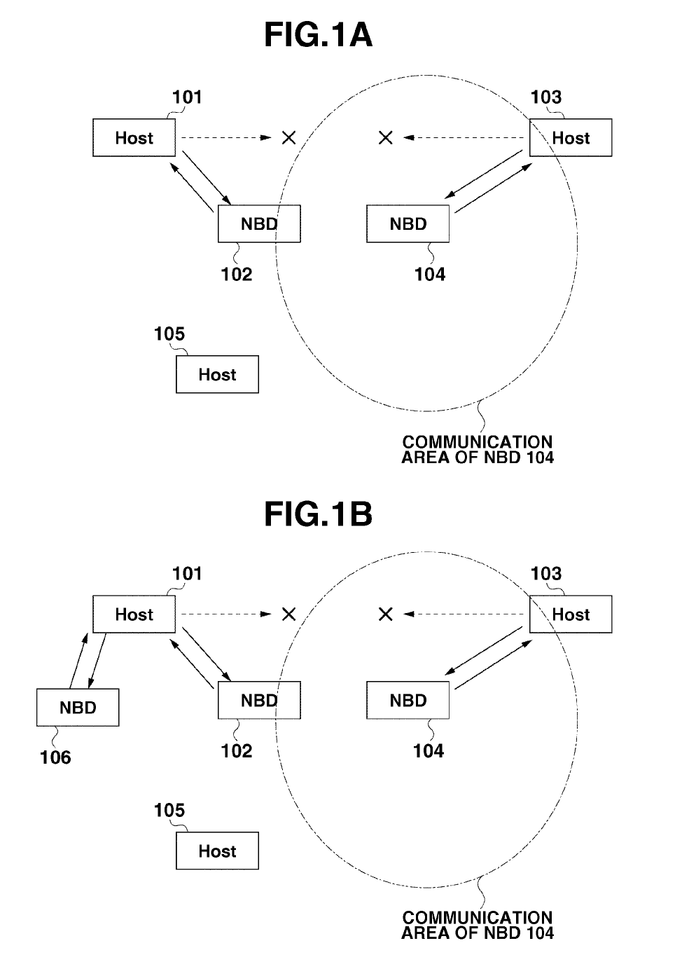

FIG. 1A illustrates a system configuration according to this exemplary embodiment. A Host 101 is a communication apparatus (Self-Beaconing Device). A Non-Beaconing Device (NBD) 102 is a communication partner. The Host 101 and the NBD 102 are wirelessly connected to each other to wirelessly communicate using Wireless USB (WUSB) specified by the WiMedia protocol. The Host 101 transmits beacons (notification signals) specified by the WiMedia, but the NBD does not. Any device compliant with the WiMedia receives the beacons to recognize the existence of the Host, and synchronizes with the Host. A Host 103 and an NBD 104 are also wirelessly connected to each other for wireless communication using WUSB.

Both of the Hosts 101 and 103 transmit beacons (notification signals) specified by the WiMedia, but the beacons from the Host 101 are not received by the Host 103 and vice versa. Accordingly, the Host cannot recognize the Host 103. In addition, the Host 101 located out of the communication area (communication range) of the NBD 104 cannot recognize the NBD 104. The Host 103 located out of the communication area of the NBD 102 cannot recognize the NBD 102. Thus, no synchronization can be established between the Hosts 101 and 103. Meanwhile, the NBD 102 is located within the communication area of the NBD 104, but no synchronization can be established between the NBDs 102 and 104 that do not transmit beacons.

A Host 105 receives beacons from the Host 101, but not from the Host 103. FIG. 1B will be described later for a second exemplary embodiment.

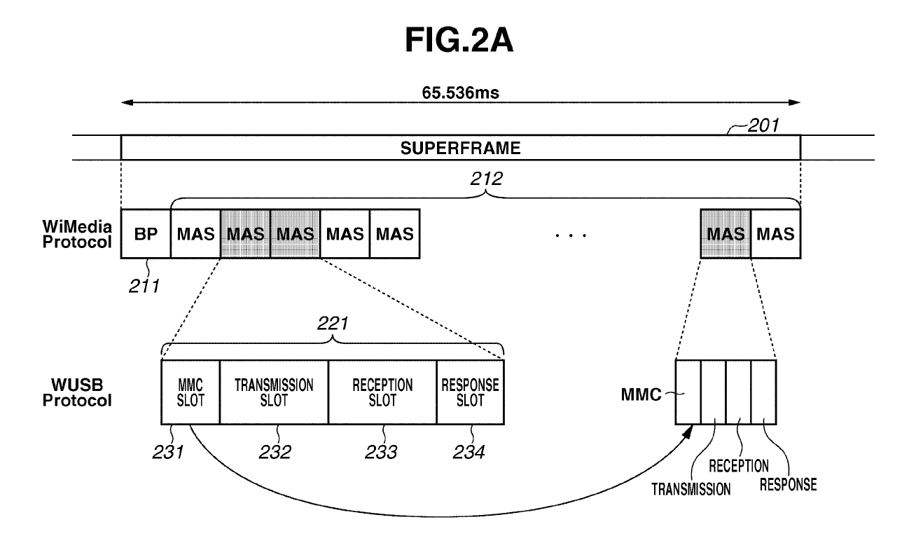

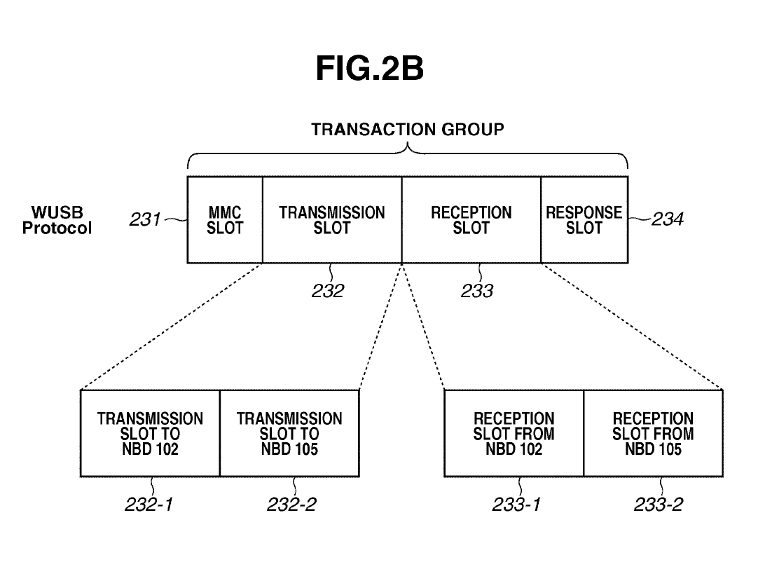

FIG. 2A illustrates a frame configuration used in the WiMedia and WUSB. A superframe 201 is specified by the WiMedia, and repeated in a predetermined cycle (65.536 ms). The superframe 201 includes a beacon period (BP) 211 for beacon transmission, and 255 time slots 212 (hereinafter referred to as MASs) for communication between communication apparatuses. Each of the time slots is a time frame, and the MAS is the abbreviation for medium access slot.

The Host reserves a MAS from MASs unused, to communicate with an NBD. The MASs unused are those that are not reserved by the Host 101 and the other Hosts in its communication range, for example. A Host can communicate with NBDs without interference by using a MAS non-reserved by other Hosts. The scheme to reserve MAS in advance for communication is called Distributed Reservation Protocol (DRP). The Host transmits the DRP information element (DRP IE) of the reserved MAS with a beacon. This allows other Hosts to recognize the reservation of the MAS (the MAS in use).

The Host 101 sets a transaction group (hereinafter, referred to as TG) 221 for WUSB communication, the group including one or more MAS reserved by the WiMedia. The TG 221 includes a micro-scheduled management command (MMC) slot 231, a transmission slot 232, a reception slot 233, and a response slot 234. The MMC slot 231 is a time slot used to transmit micro-scheduled management command (MMC) signals using the WUSEB by the Host 101. The MMC signals each include information about timing allocation for the transmission slot 232, the reception slot 233, and the receipt response slot 234. The MMC signal also includes information about the time a next MMC starts.

The transmission slot 232 is a time slot used to transmit data from Host to NBD. The reception slot 233 is a time slot used to receive data by Host from NBD, that is, to transmit data from NBD to Host. The response slot 234 is a time slot used to transmit a receipt response (Hand Shake Out) from NBD to Host. An NBD returns Ack when the data transmitted from a Host to the NBD through the transmission slot 232 is normally received, while the NBD returns Nack when the data is not received normally. FIG. 2B will be described later for a second exemplary embodiment.

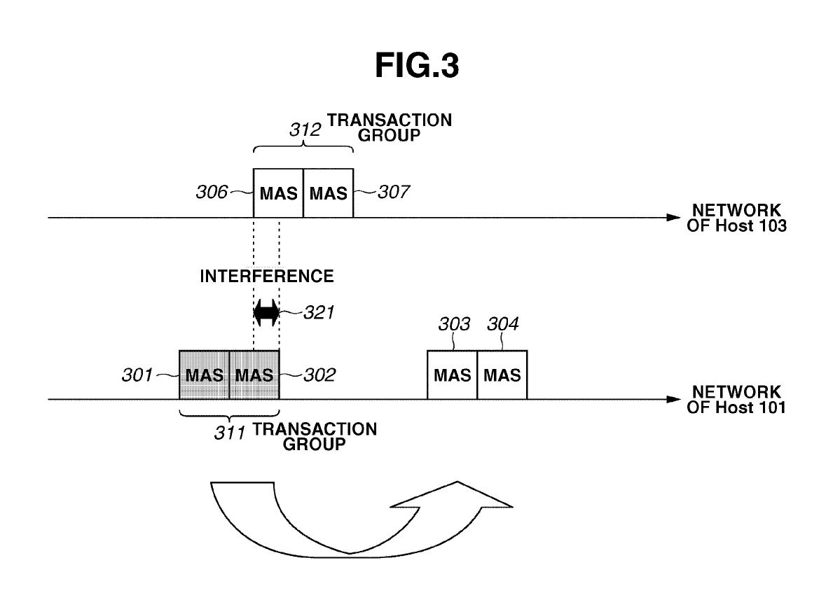

A case where the NBDs 102 and 104 interfere with each other is described with reference to FIG. 3. The Host 101 reserves MASs 301 to 304, and uses MASs 301 and 302 to set a TG 311. Using the TG 311, the Host 101 communicates with the NBD 102. Meanwhile, the Host 103 reserves MASs 306 and 307, and sets them as a TG 312. Using the TG 312, the Host 103 communicates with the NBD 104.

The Hosts 101 and 103 do not recognize the mutual existences, and reserve the MASs independently. As a result, a part of the reserved MASs share the same time zone 321. In the time zone 321, the communication is carried out between the Host 101 and the NBD 102 and between the Host 103 and the NBD 104 in parallel. The data transmission from the NBD 104 to the Host 103 and data reception by the NBD 102 from the Host 101 during the time zone 321 cause interference in the signals received by the NBD 102. The interference disturbs data reception at the NBD 102 from the Host 101. The data reception at the NBD 102 and the data transmission from the NBD 104 are performed periodically, and thereby interference occurs in every superframe, resulting in poor communication quality. In the case where a communication partner cannot receive MMCs from its Host, the communication therebetween may be cut off.

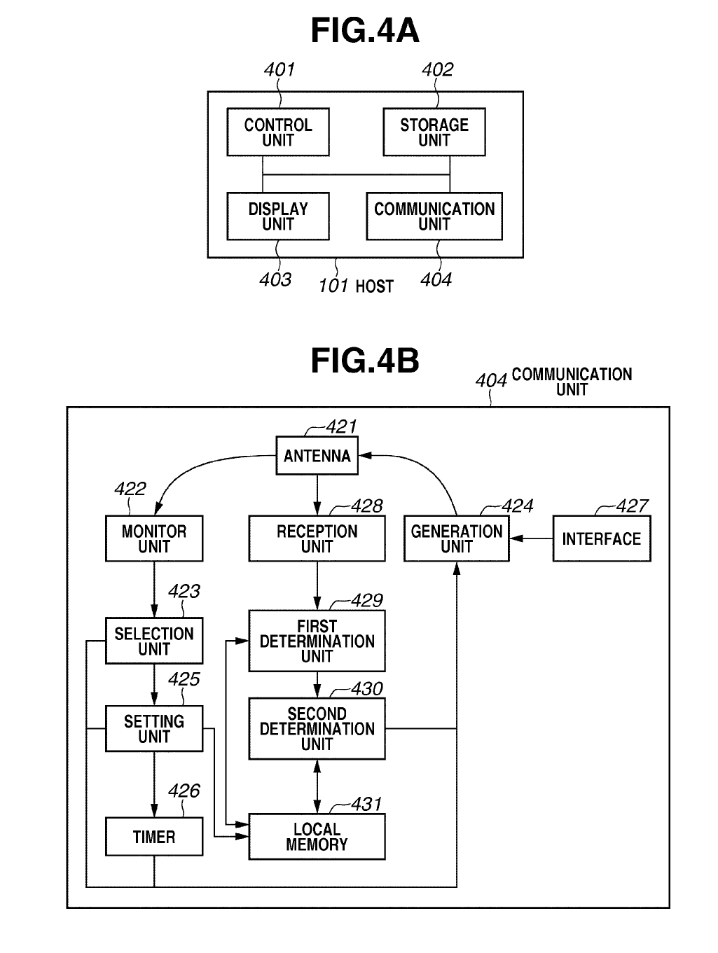

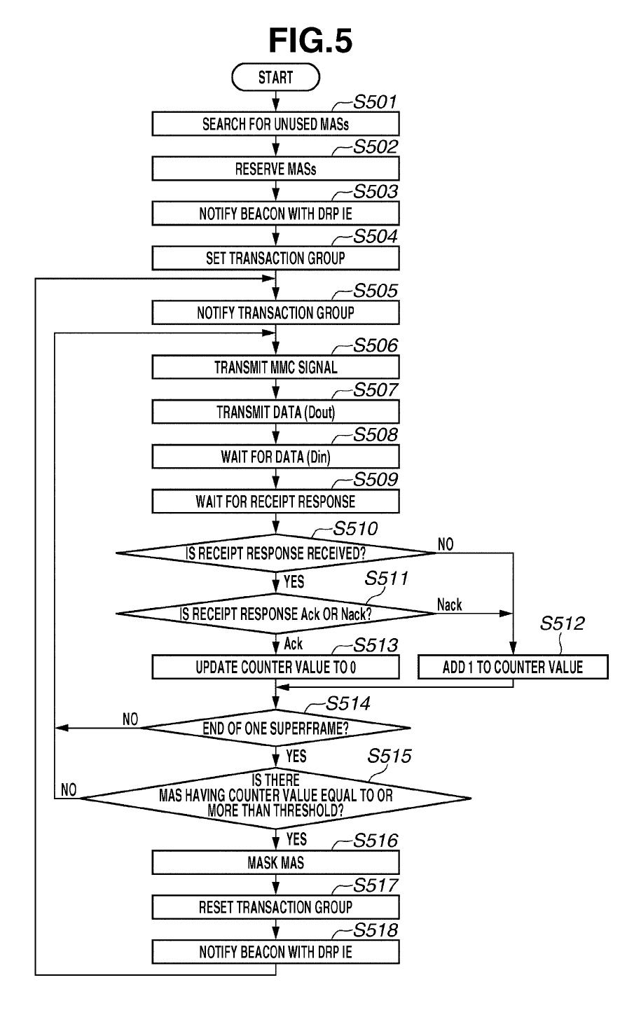

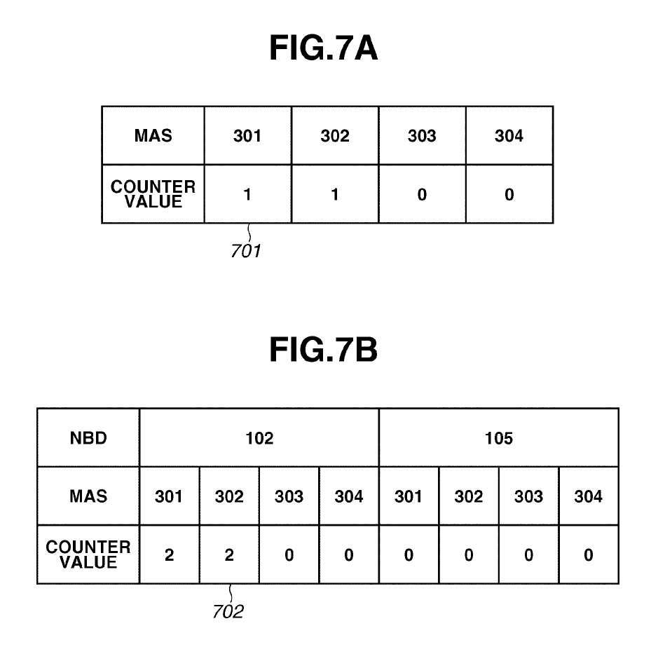

FIG. 4A illustrates a hardware configuration of the Host 101. FIG. 4B will be described later. A control unit 401 includes a central processing unit (CPU). A storage unit 402 includes a read only memory (ROM) and a random access memory (RAM). The storage unit 402 stores a program to implement the flowchart in FIG. 5, and a MAS table 701 in FIG. 7A. The MAS table 701 manages MASs as to which interference occurs in the NBD 102 . A display unit 403 displays information to be notified to users. A communication unit 404 includes an antenna to communicate with the NBD 102.

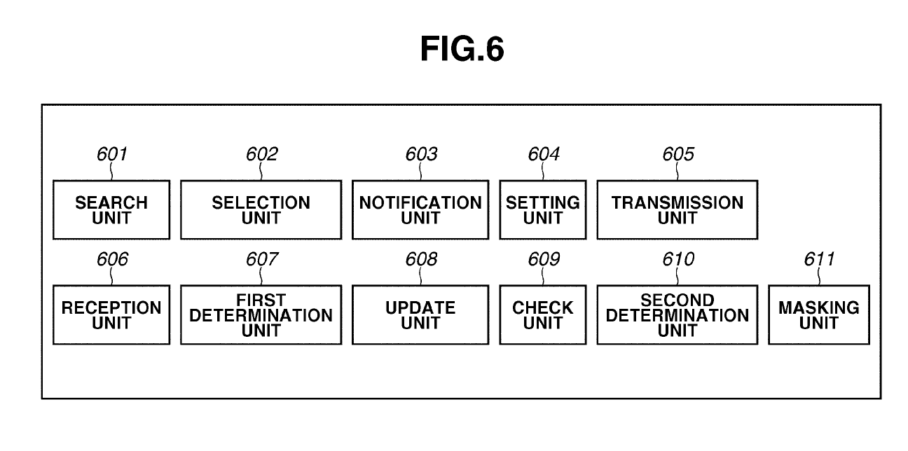

FIG. 5 is a flowchart executed by reading a program in the storage unit 402 by the control unit 401. FIG. 6 illustrates a software block diagram that is configured by execution of the flowchart.

In step S501, a search unit 601 searches for unused MASs from the superframe 201. In step S502, a selection unit 602 selects MASs for communication with the NBD 102, from the searched unused MASs. In this exemplary embodiment, the selection unit 602 selects MASs 301 to 304. In step S503, a notification unit 603 notifies information (DRP IE) about the selected MASs with a beacon, and reserves the MASs.

In step S504, a setting unit 604 sets a TG using the reserved MASs. In this exemplary embodiment, the setting unit 604 sets a TG 311 using the MASs 301 and 302. In step S505, a transmission unit 605 transmits the information of the set TG 311 to the NBD 102. When time of the reserved MASs comes, in step S506, the transmission unit 605 transmits an MMC signal using the MMC slot 231. In step S507, the transmission unit 605 transmits data (Dout) to the NBD 102 using the transmission slot 232.

In step S508, a reception unit 606 waits for data (Din) from the NBD 102 using the reception slot 233. The reception unit 606, when the data (Din) is received from the NBD 102, accepts the data. In step S509, the reception unit 606 waits for a receipt response from the NBD 102 using the response slot 234. The reception unit 606, when a receipt response from the NBD 102 is received, accepts the receipt response.

In step S510, a determination unit 607 determines whether or not the reception unit 606 received a receipt response from the NBD 102. If reception unit 606 received a receipt response, the process goes to step S511. If reception unit 606 did not receive receipt response, the process goes to step S512. In this case, the NBD 102 could not receive an MMC signal and did not recognize the timing of the response slot 234, resulting in no transmission of a receipt response. MMC signal is not received, for example, in the case where the NBD 104 transmits data to the Host 103 at the timing when the NBD 102 receives an MMC signal, and thereby interference occurs in the NBD 102 and disturbs normal reception of the MMC signal at the NBD 102.

In step S511, the determination unit 607 determines whether the receipt response received by the reception unit 606 from the NBD 102 is Ack or Nack. When the receipt response is Ack, the process goes to step S513. When the receipt response is Nack, the process goes to step S512. The Nack is a receipt response, for example, it is transmitted in the case where interference occurs in the NBD 102 when the NBD 102 receives data (Dout) from the Host 101, and the interference disturbs normal reception of the data by the NBD 102. Herein, assume that at the timing when the NBD 102 receives data (Dout) from the Host 101, the NBD 104 transmits data to the Host 103, which causes interference in the NBD 102 that disturbs normal reception of the data at the NBD 102. As a result, the NBD 102 transmits Nack as a receipt response.

The process goes to step S512 when the reception unit 606 received no receipt response, or the reception unit 606 received Nack as a receipt response. In either case, the NBD 102 failed to transmit a signal (data signal or MMC signal). Thus, in step S512, an update unit 608 adds 1 to each of the counter values corresponding to the MASs in the TG among items of the MAS table 701. Herein, because interference occurs in the NBD 102 due to use of the TG 311, the counter values for the MASs 301 and 302 in the TG 311 are each increased by 1. In this way, the Host 101 manages the number of interferences that occur in the NBD 102, using the MAS table 701.

In contrast, when the NBD 102 successfully received the data (Dout) and MMC signals, the process goes to step S513. In step S513, the update unit 608 updates the counter values to 0, corresponding to the MASs in the TG. Every time the NBD 102 succeeded in receiving the data (Dout) and MMC signals, the counter values are updated to 0, limiting the counter values to 2 or less unless the NBD 102 serially fails to receive signals.

In step S514, a check unit 609 checks if one superframe ended or not. If one superframe ended, the process goes to step S515, otherwise the process goes to step S506. In step S515, a determination unit 610 determines whether or not the MAS table 701 includes a MAS having a counter value equal to or more than a threshold (herein, 3) . If the MAS has a threshold equal to or more than the threshold, the NBD 102 serially failed to receive a signal. Thus, the Host 101 determines that the failed reception at the NBD 102 is caused not by a temporal noise (burst error) but by periodic interference from another WiMedia device (the NBD 104 in this exemplary embodiment) . This is because burst error is not likely to cause serial failures in signal reception. In this way, the Host 101 detects interference at the NBD 102. When it is determined in step S515 that a MAS has a counter value equal to or more than a threshold, the process goes to step S516, otherwise the process goes to step S506.

In step S516, a masking unit 611 masks the MAS having a counter value equal to or more than the threshold. The masking is performed by the Host 101 stopping communication using the MAS with a communication partner suffering from interference, and reservation of the MAS by other Hosts is blocked. In this exemplary embodiment, in step S518 which will be described later, the masked MAS is notified as a reserved MAS, to block reservation of the MAS by other Hosts. The masking prevents the Host 105 from reserving the MAS. Thus, the interference between the Host 105 and its communication partner (not illustrated) and the NBD 104 is avoided.

The masked MAS is not used for communication, and thereby transmits no MMC. Accordingly, among the information elements in an MMC, the value of the information element indicating the timing of a next MMC is changed. The information of the masked MAS is stored in the storage unit 402. In step S517, the setting unit 604 removes the masked MAS from the MASs already reserved, and resets the remaining MASs as a TG. In this exemplary embodiment, the setting unit 604 resets the MASs 303 and 304 as a TG for communication with the NBD 102. Alternatively, the search unit 601 may again search for unused MASs, and the selection unit 602 selects new MASs from the searched MASs, so that the setting unit 604 sets the selected MASs as a TG. In this way, the Host 101 communicates with the NBD 102 using new MASs, which allows the Host 101 to continue the communication with the NBD 102.

In step S518, the notification unit 603 sends a beacon with DRP IE that includes the masked MASs (herein, MASs 301 and 302) as reserved MASs. In this way, the reservation of the MASs can be continued, preventing the Host 101 from reserving the same MASs. This reduces the process load of the Host 101. This also prevents the Host 105 from reserving those MASs. Accordingly, interference between the Host 105 and its communication partner (not illustrated) and the NBD 104 can be prevented.

As described above, a communication apparatus (Host 101) detects periodic interference at its communication partner (NBD 102) based on a receipt response from the communication partner. More specifically, if a communication apparatus serially fails to receive a receipt response or a response indicating a successful data receipt from its communication partner, the communication apparatus determines that periodic interference occurs at the communication partner because of data transmission from the other communication apparatus (NBD 104) . Thus, it is recognized that not burst error but periodic interference occurs at the communication partner because of data transmission from the other communication apparatus.

The communication apparatus, when periodic interference is detected at the communication partner, masks the interfering MASs. In other words, the communication apparatus stops communication using the MASs with the communication partner, and also prohibits the other Hosts from reserving the MASs. Consequently, the communication apparatus establishes no communication using the MASs that causes interference at the communication partner, so that communication quality is enhanced. This also reduces the risk of cutting off of communication with the communication partner due to non-receipt of MMC at the communication partner, making the communication more stable.

The reservation of the masked MASs by other Hosts is blocked, and thereby the reservation of the same MASs by the Host 101 can be prevented. This reduces process load of the Host 101. Furthermore, the Host 105 residing in the communication range of the Host 101 does not reserve the masked MASs. Accordingly, interference between the Host 105 and its communication partner (not illustrated) and the NBD 104 can be prevented. More specifically, the Host 101 continues to reserve the masked MASs, so that other Hosts cannot reserve those MASs.

The above exemplary embodiment can be implemented only by hardware in the communication unit 404. FIG. 4B illustrates a hardware configuration of the communication unit 404 in this case.

In step S501, a monitor unit 422 monitors radio wave conditions through an antenna 421, and searches for unused MASs. The monitor unit 422 notifies a selection unit 423 of information of the searched MASs. In step S502, the selection unit 423 reserves MASs based on the notified MAS information, and notifies a generation unit 424 and a setting unit 425 of information of the reserved MASs. The generation unit 424 generates and modulates a beacon that contains the notified MAS information, and supplies the beacon with the information to the antenna 421. In step S503, the antenna 421 transmits the supplied beacon. In step S504, a setting unit 425 sets a TG based on the notified MAS information. The setting unit 425 notifies the generation unit 424 and a timer 426 of the set TG information. The generation unit 424 supplies data containing the TG information to the antenna 421. In step S505, the antenna 421 transmits the data. The timer 426 reports that it has reached the time to transmit an MMC signal, to the generation unit 424. When the report is received, the generation unit 424 generates and modulates the MMC signal, and supplies it to the antenna 421. In step S506, the antenna 421 transmits the supplied MMC signal. When the timer 426 notifies that time for transmitting data (Dout) has come, the generation unit 424 obtains data through an interface (I/F) 427, and supplies the data to the antenna 421. In step S507, the antenna 421 transmits the data.

The timer 426 notifies a reception unit 428 that it has reached the time for transmitting a receipt response. The reception unit 428, when a receipt response is received from a communication partner, supplies the receipt response to a determination unit 429. The reception unit 428, if it could not receive a receipt response, notifies a determination unit 430 of the fact of the non-receipt. In step S513, when the receipt response is Ack, the determination unit 429 accesses a local memory 431, and updates the MAS table 701 stored in the local memory 431. In contrast, when the receipt response is Nack, the determination unit 429 notifies the determination unit 430 of the receipt of Nack. In step S512, the determination unit 430 updates the MAS table 701 in the local memory 431. In step S515, the determination unit 430 refers to the updated MAS table 701, and determines presence/absence of a MAS having a counter value equal to or more than a threshold. When a MAS having a counter value equal to or more than a threshold is detected, the determination unit 430 notifies the setting unit 425 and the generation unit 424 of information of the MAS. In step S516, the setting unit 425 masks the notified MAS, and in step S517, resets a TG using a new MMC. The generation unit 424 generates a beacon with DRP IE containing the notified MASs as reserved MASs, and supplies the beacon to the antenna 421. In step S518, the antenna 421 transmits the beacon. This scheme provides the same effect.

In the first exemplary embodiment, MASs causing interference are masked. In a second exemplary embodiment, a Host does not communicate with a communication partner where interference is caused by a MAS, but communicates with the other communication partners using the MAS.

FIG. 1B illustrates a system configuration of this exemplary embodiment. The elements 102 to 105 are the same as those in the first exemplary embodiment, which will not be described. A Host 101 is connected to an NBD 102 and an NBD 106 for wireless communication using Wireless USB (WUSB). A NBD 105 is connected to the Host 101 for wireless communication using WUSB. The NBD 106 is located out of the communication area of an NBD 104, and interferes with no data transmission from the NBD 104. The hardware configuration of the Host 101 is similar to that of the first exemplary embodiment and is illustrated in FIG. 4, which will not be described. A storage unit 402 in this exemplary embodiment, however, stores a MAS table 702 in FIG. 7B.

FIG. 2B illustrates a frame configuration of a TG set by the Host 101. The transmission slot 232 further includes a transmission slot 232-1 to the NBD 102, and a transmission slot 232-2 to the NBD 106. The reception slot 233 further includes a reception slot 233-1 from the NBD 102, and a reception slot 233-2 from the NBD 106.

FIG. 5 illustrates a flowchart that is executed by reading a program in a storage unit 402 by a control unit 401.

In step S501, a search unit 601 searches for unused MASs from a superframe 201. In step S502, a selection unit 602 selects MASs for communication with the NBDs 102 and 105, from the searched unused MASs. In this exemplary embodiment, the selection unit 602 selects MASs 301 to 304. In step S503, a notification unit 603 notifies information (DRP IE) of the selected MASs with a beacon, and reserves the MASs.

In step S504, a setting unit 604 sets a TG based on the reserved NASs. In this exemplary embodiment, the setting unit 604 sets a TG 311 using the MASs 301 and 302. In step S505, a transmission unit 605 transmits information of the set TG 311 to the NBDs 102 and 105. In step S506, at the time of the reserved MAS, the transmission unit 605 transmits MMC signals using an MMC slot 231. In step S507, the transmission unit 605 transmits data (Dout1) to the NBD 102, and data (Dout2) to the NBD 106, using the transmission slot 232. In step S508, a reception unit 606 waits for data (Din) from the NBDs 102 and 105 using the reception slot 233. In step S509, the reception unit 606 waits for a receipt response from each of the NBDs 102 and 105 using the response slot 234. The reception unit 606, when a receipt response is received from each of the NBDs 102 and 105, accepts the receipt response.

In step S510, a determination unit 607 determines, for each NBD, whether or not the reception unit 606 received a receipt response. When the reception unit 606 received a receipt response, the process goes to step S511, otherwise the process goes to step S512. In step S511, the determination unit 607 determines, for each NBD, whether the receipt response received at the reception unit 606 is Ack or Nack.

In step S512, an update unit 608 adds 1 to the counter values corresponding to the MASs in the TG according to determination on each NBD, among the items in the MAS table 702. In contrast, in step S513, the update unit 608 updates the counter values corresponding to the MASs in the TG for each NBD determined, among the items in the MAS table 702.

Because the NBD 102 suffers from interference in this exemplary embodiment, the counter values of the MASs 301 and 302 for the NBD 102 are each increased by 1, to be 3. In contrast, the counter values of the MASs 301 and 302 for the NBD 106 showing no interference are updated to 0.

In step S514, a check unit 609 checks whether one superframe ended. When one superframe ended, the process goes to step S515, otherwise the process goes to step S506. In step S515, a determination unit 610 determines whether there is a MAS having a counter value equal to or more than a threshold (3, in this exemplary embodiment) in the MAS table 702. In step S516, a masking unit 611 stops communication using the MAS with the NBD having a MAS of a counter value equal to or more than the threshold. In this exemplary embodiment, the masking unit 611 stops communication using MASs 301 and 302 with the NBD 102.

In step S517, the setting unit 604 resets a TG by removing the masked MASs from the reserved MASs. In this exemplary embodiment, the setting unit 604 resets a TG using the MASs 303 and 304 to communicate with the NBD 102. The setting unit 604 also resets a TG using the MASs 301 and 302 to communicate with the NBD 106. In step S518, the notification unit 603 sends a beacon containing DRP IE. Then, the process goes to step S505.

As described above, detection of interference is performed for each communication partner, and the MAS causing interference is not allocated to the communication partner suffering from the interference to improve communication quality. In contrast, the communication with a communication partner that does not suffer from the interference but uses the MAS is continued, leading to effective use of the band.

The present invention also provides a computer readable recording medium (or computer-readable storage medium) that stores a program code of software that achieves the above described functions, so that the system or apparatus reads and executes the program code stored in the recording medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-288467 filed Dec. 18, 2009, which is hereby incorporated by reference herein in its entirety.

What is claimed is:

1. A communication apparatus comprising:
a reservation unit configured to reserve a time frame to communicate with a communication partner;
a determination unit configured to determine presence or absence of interference at the communication partner in the communication with the communication partner using the time frame reserved by the reservation unit; and
a masking unit configured to mask the time frame when the determination unit determines presence of the interference.

2. The communication apparatus according to claim 1, wherein the masking unit stops communication using the time frame with the communication partner, and prohibits other communication apparatuses from reserving the time frame.

3. The communication apparatus according to claim 2, wherein the masking unit continues the reservation of the time frame by the reservation unit, to prohibit other communication apparatuses from reserving the time frame.

4. The communication apparatus according to claim 1, further comprising:
a notification unit configured to notify the time frame reserved by the reservation unit.

5. The communication apparatus according to claim 1, further comprising:
a communication unit configured to communicate with the communication partner using a time frame different from the time frame, when the determination unit determines presence of the interference.

6. The communication apparatus according to claim 5, wherein, after the masking unit masks the time frame, the reservation unit reserves a new time frame different from the time frame, and
wherein the communication unit communicates with the communication partner using the new time frame reserved by the reservation unit.

7. The communication apparatus according to claim 1, wherein the reservation unit reserves the time frame among superframes that are repeated in a predetermined cycle.

8. The communication apparatus according to claim 1, further comprising a transmission unit configured to transmit data to the communication partner,
wherein the determination unit makes the determination based on a receipt response from the communication partner responding to the data transmitted from the transmission unit.

9. The communication apparatus according to claim 8, wherein the determination unit determines presence of the interference at the communication partner when the determination unit serially fails to obtain the receipt response that indicates a normal receipt of the data at the communication partner.

10. The communication apparatus according to claim 1, wherein the communication apparatus communicates with a plurality of communication partners,
wherein the determination unit makes the determination of the interference on each of the plurality of communication partners, and
wherein the masking unit stops communication in the time frame with the communication partner where presence of the interference is determined by the determination unit among the plurality of communication partners.

11. A method of controlling a communication apparatus, comprising the steps of:
reserving a time frame to communicate with a communication partner;
determining presence or absence of interference at the communication partner in the communication with the communication partner using the time frame reserved by the reservation unit; and
masking the time frame when presence of the interference is determined.

12. A computer-readable storage medium containing executable instructions for implementing the control method according to claim 11, to be executed by a computer to control a communication apparatus.
